(19) United States
(12) Patent Application Publication
(10) Pub. No.: US 2021/0183123 A1
(43) Pub. Date: Jun. 17, 2021

(54) Method and System for Providing Multi-Dimensional Information Using Card

(71) Applicant: Photo Production Kingdom of Light Co., Ltd, Seoul (KR)

(72) Inventor: Ji Young Yun, Seoul (KR)

(21) Appl. No.: 17/032,389

(22) Filed: Sep. 25, 2020

(30) Foreign Application Priority Data
Dec. 12, 2019 (KR) 10-2019-0165273

(51) Int. Cl. G06T 11/60; G06K 9/62; G06T 7/00; G06F 40/134; G06T 3/40; G06Q 30/06; G06F 16/14

(52) U.S. Cl. CPC G06T 11/60; G06K 9/6267; G06T 7/0002; G06K 9/2081; G06T 3/40; G06Q 30/0601; G06F 16/148; G06F 40/134

(57) ABSTRACT

A method and system for providing multi-dimensional information using a post card is proposed, the method including creating images that a user prefers as primary depth content which is the form of a post card according to user personal information and cookie information, creating secondary depth content by linking each object to URLs including information of interest extracted from objects included in the image of the form of the post card and the user personal information and cookie information, creating third depth content including purchase links when the user selects the secondary depth content, and providing rewards according to whether a user's purchase event occurs or the number of times that the registered image is used. The quality of the images uploaded to the image providing server is evaluated to provide other users with images of high-quality above a certain level as a result of the evaluation.

### CROSS REFERENCE TO RELATED APPLICATION

The present application claims priority to Korean Patent Application No. 10-2019-0165273, filed on Dec. 12, 2019 the entire content of which is incorporated herein for all purposes by this reference.

### BACKGROUND OF THE INVENTION

### Field of the Invention

The present disclosure relates to an image providing system and, more particularly, to a method and system for providing multi-dimensional information using a post card, by which images that a user prefers are extracted through cookie information and personal information stored in a smart terminal and the extracted images is provided to user information of interest by linking to the information in a multi-dimensional manner.

### Description of the Related Art

Unless otherwise indicated herein, the descriptions set forth in this section are meant to be related art to the claims of this application and are not to be admitted to related art even though they are included in this section.

A smartphone is an intelligent terminal in which computer support functions, such as Internet communication and information searching, are added to a mobile phone and a user may install desired applications. A technology thereof has been rapidly developing. The quality of a camera installed in the smart phone has been also constantly improving. The latest specification mobile phone cameras are equipped with depth sensors, infrared sensors, and the like, so that even non-professionals can easily obtain high-quality images using their smartphones. Accordingly, SNS and various applications where image-based postings are uploaded are actively used, and various image-based contents and platforms are being created.

Pinterest is an image-oriented social network service that shares, searches, and scraps images or pictures and is a compound word of pin and interest. Pinterest is a social network service that allows a user to post images that she/he is interested in, in such a manner as to scarp the images via a pin, and to share the images with other users.

Currently, Pinterest focuses on content collection rather than content production, and allows users to post and manage their favorite image information on specific topics. In addition, when the user likes other users' images, she/he can share the images using a function termed “pin it”. Pinterest has a user interface (UI) that is simple and image-oriented compared to other existing social network services, so that Pinterest is termed “visual social curation service”. As the most popular visual social curation services in recent years, there are Pinterest and Instagram. Such a result is due to phenomena that users want to be provided with high-quality content like an art curation at an art gallery in an online information-abundant environment and users prefer content centered on images.

However, since the visual social curation service in the related art focuses on content collection rather than content reproduction, there is a limitation in that it is not possible to provide other related information by using images that the user prefers, or to create content including all the information desired by the user in a single image.

### DOCUMENTS OF RELATED ART

(Patent Document 1) Korean Patent No. 10-1649034 (2016. 08.10)

(Patent Document 2) Korean Patent No. 10-1809204 (2017.12.08)

### SUMMARY OF THE INVENTION

An objective of the present disclosure is to provide a method and system for providing multi-dimensional information using a post card, the method including creating images that a user prefers as primary depth content which is the form of a post card according to user personal information and cookie information, and creating secondary depth content by linking each object to URLs including information of interest extracted from objects included in the image of the form of the post card and the user personal information and cookie information.

In addition, an objective of the present disclosure is to provide a method of providing multi-dimensional information using a user preference image-providing server and a post card, the method including providing third depth content including purchase links when the user selects the secondary depth content and providing rewards according to whether a user's purchase event occurs or the number of times that the registered image is used in the form of the post card.

In addition, an objective of the present disclosure is to provide a method of providing multi-dimensional information, the method including evaluating the quality of the images uploaded to the image providing server to provide other users with images of high-quality equal to or greater than a certain level as a result of the evaluation.

In order to achieve the above objectives, a method of providing multi-dimensional information using a post card of an image providing system is provided according to an embodiment of the present disclosure, the image providing system including an image providing server and a user terminal, the method including: by the image providing server, selecting a post card image to be transmitted to a user using cookie information and personal information of the user terminal to create first depth content in consideration of user preference; by the image providing server, extracting multiple objects included in the selected post card image to create secondary depth content by linking to URLs outputting metadata of the extracted objects and information associated with the cookie information or the personal information; and by the image providing server, outputting the created secondary depth content via user selection to create third depth content including a purchase link or object related information included in the output secondary depth content.

In order to achieve the above objectives, a system for providing multi-dimensional information is provided according to another embodiment of the present disclosure, the system including a user terminal transmitting user personal information, cookie information, and stored images; and an image providing server classifying the received image, selecting preference images according to the user personal information and cookie information, inserting multi-dimensional information into the selected preference images to create related content, and transmitting the created related content to the user terminal.

According to the method of providing multi-dimensional information using a post card and the image providing system as described above, information desired by the user can be compressedly provided in a single image, by creating images that the user prefers as the primary depth information using the cookie information and personal information stored in the smart terminal of the user, and linking the created primary depth information to all URLs capable of identifying detailed information of the objects extracted as user information of interest.

In addition, since the one-dimensional related information transmitted to the user is created in the form of a post card in consideration of user preference information, it is possible to provide the information to users without a feeling of rejection to advertisement content, unlike advertisement brochures and pamphlets that are uniformly provided to consumers. Accordingly, the embodiment according to the present disclosure may be used in the form of customized advertisement content for various stores such as a department store to improve the advertisement effect.

In addition, rewards are provided to users who upload high-quality images and users who upload images with high preference to generate additional revenue.

The effects of the present invention are not limited to the above mentioned effects, and should be understood to include all effects that can be inferred from the configuration of the invention described in the detailed description or claims of the present invention.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram showing a system for providing multi-dimensional information according to an embodiment;

FIG. 2 is a diagram showing a data processing configuration of a user preference image-providing server according to an embodiment;

FIG. 3 is a diagram showing a detailed data processing block of the image providing server according to an embodiment;

FIG. 4 is a diagram showing primary depth content and secondary depth content according to an embodiment;

FIG. 5 is a diagram showing third depth content according to an embodiment;

FIG. 6 is a flow chart showing data processing for providing multi-dimensional information using a post card image according to an embodiment;

FIG. 7 is flow chart showing data processing for creating related content according to an embodiment;

FIG. 8 is a diagram showing primary depth content according to an embodiment; and

FIG. 9 is a diagram showing secondary depth content and third depth content according to an embodiment.

### DETAILED DESCRIPTION OF THE INVENTION

Advantages and features of the present disclosure and a method of achieving them will become apparent with reference to the embodiments described below in detail together with the accompanying drawings. However, the present disclosure is not limited to the embodiments disclosed below, but may be implemented in various different forms. Only these embodiments are provided to complete the disclosure of the present invention, and to fully inform the scope of the invention to those of ordinary skill in the art, and the invention is only defined by the scope of the claims. The same reference numerals refer to the same elements throughout the specification.

In describing embodiments of the present invention, if it is determined that a detailed description of a known function or configuration may unnecessarily obscure the subject matter of the present invention, a detailed description thereof will be omitted. In addition, terms to be described later are defined in consideration of functions in an embodiment of the present disclosure and may vary depending on the intention or custom of users or operators. Therefore, the definition should be made based on the contents throughout this specification.

FIG. 1 is a diagram showing a system for providing multi-dimensional information according to an embodiment.

Referring to FIG. 1, a system for providing multi-dimensional information according to an embodiment may be configured to include an image providing server 100 and a user terminal 200.

The user terminal 200 transmits terminal-specific information, personal information, cookie information, and images stored in the terminal to the image providing server 100.

The image providing server 100 classifies images received from the user terminal or an external server and selects preferred images according to user personal information and cookie information, thereby creating related content by inserting multi-dimensional information into the selected preferred images. Then, the created related content is transmitted to the user terminal.

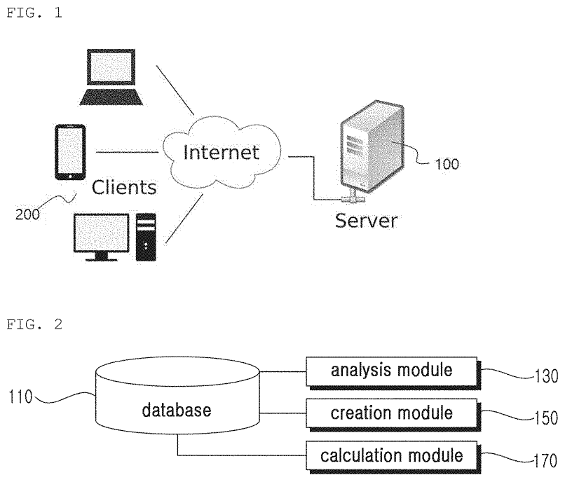

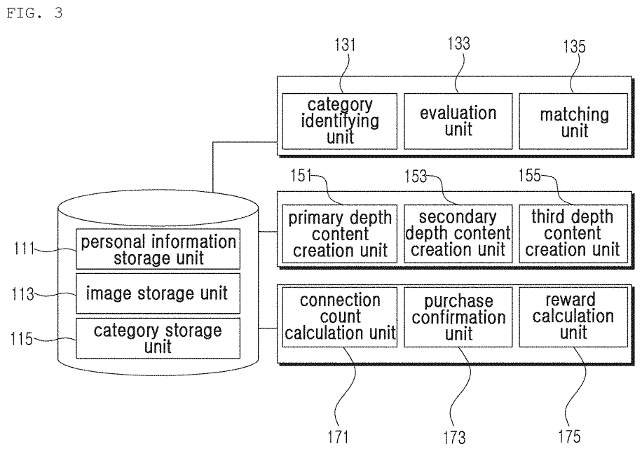

FIG. 2 is a diagram showing a data processing configuration of a user preference image-providing server according to an embodiment.

Referring to FIG. 2, the user preference image-providing server according to an embodiment may be configured to include a database 110, an analysis module 130, a creation module 150, and a calculation module 170. The term “module” used in this specification should be interpreted as being capable of including software, hardware, or a combination thereof, depending on the context in which the term is used. For example, the software may be machine language, firmware, embedded code, and application software. As another example, the hardware may be a circuit, a processor, a computer, an integrated circuit, an integrated circuit core, a sensor, a Micro-Electro-Mechanical System (MEMS), a passive device, or a combination thereof.

In the database 110, personal information on users of the user preference image-providing server is stored, and image data uploaded by the server users is also stored. In addition, in the database 110, a series of data required to operate a multi-dimensional information providing application through the user preference images is stored, thereby making it possible for the application to be transmitted to the users in a distributed manner. In addition, the database 110 stores category information for classification of the images registered by a user and an external server.

The analysis module 130 analyzes the uploaded image, identifies a category in which the analyzed image is to be included, and determine the quality of the images according to evaluation factors. According to an embodiment, the quality of the images may be calculated by scaling each of evaluation factors, such as quality, composition, focusing, and number of recommendations, in order to objectively evaluate the quality of the registered images.

The creation module 150 analyzes personal information and cookie information of users who have subscribed to the server to create primary depth content, which is a post card image to be transmitted to the user. For example, the creation module 150 extracts images that the user prefers through a gender, age group, field of interest of the server user, and cookie information recorded in the user terminal, and convert the extracted image into the form of a post card. Specifically, when it is determined that the user is interested in a specific brand or a celebrity, the creation module 150 extracts pictorials and images associated with the user field of interest and converts them into the form of the post card to create the primary depth content.

In addition, the creation module 150 creates secondary depth content using the primary depth content. According to an embodiment, the secondary depth content includes objects included in an image, which is the primary depth content, and object information that the user, who has received the post card of the primary depth content, is likely to prefer. For example, the creation module 150 extracts each of a plurality of objects included in the post card image selected for each user, the secondary depth content may be generated by linking metadata of the extracted objects to URLs to which information related to the cookie information or personal information is output. Specifically, the object included in the post card image of the primary depth content, is detected through edge extraction, etc., and the detected object is linked to a URL based on user's information of interest. When a user touches a specific object included in the post card image, the creation module 150 may be connected to the URL providing the user information of interest.

In addition, the creation module 150 generates third depth content including purchase links and detailed information of the objects included in the output secondary depth content.

The calculation module 170 calculates a reward provided to a server user according to an adoption frequency and an image evaluation result of the image registered in the server, and the user's actual purchase event.

According to an embodiment, when the image information registered by the user is selected as primary depth content of other user and transmitted to the other user, the calculation module 170 may provide rewards to the user who has registered the corresponding image according to a transmission frequency and the number of times that the image is selected as the primary depth content. In addition, when the image uploaded by a server user has a high evaluation result of a certain level or higher in terms of several evaluation factors, the calculation module 170 may provide the user with rewards for the evaluation result. In addition, when a user who has received related content purchases a related product within a certain period of time or purchases a product through links included in the related content, the calculation module 170 may calculate the revenue generated through the purchase and provide the same with the system administrator.

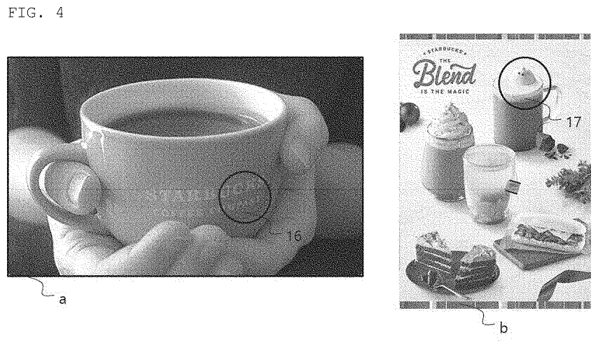

FIG. 3 is a diagram showing a detailed data processing block of the image providing server according to an embodiment.

Referring to FIG. 3, the database 110 of the user preference image-providing server according to an embodiment may be configured to include a personal information storage unit 111, an image storage unit 113, and a category storage unit 115; the analysis module 130 may be configured to include a category identifying unit 131, an evaluation unit 133, and a matching unit 135; the creation module 150 may be configured to include a primary depth content creation unit 151, a secondary depth content creation unit 153, and a third depth content creation unit 155; and the calculation module 170 may be configured to include a connection count calculation unit 171, a purchase confirmation unit 173, and a reward calculation unit 175.

The personal information storage unit 111 of the database 110 stores terminal information of a server user, user cookie information, and personal information such as field of interest, gender, and age of a user. The image storage unit 113 categorizes and stores image data transmitted from a user or an external server according to categories, and the category storage unit 115 stores category information into which images are to be classified. The picture classification category according to an embodiment may include keywords such as nouns, verbs, adjectives, etc. indicating types and actions of objects included in the image. Specifically, in the classification category, keywords, such as dogs and cats corresponding to nouns, jumping and sleeping corresponding to verbs, comfortable and soft corresponding to adjectives, may be stored as category data. In addition, the category storage unit 115 stores related information of each word matched with the images.

The category identifying unit 131 of the analysis module 130 analyzes the image uploaded to the server and identifies the category into which the image is to be included. For example, the analysis module 130 identifies detailed object information such as a type, operation, and state of an object included in the image, and matches the image with a category corresponding to the same. The analysis module 130 according to an embodiment may match a category with each keyword of detailed object information included in the image.

The evaluation unit 133 evaluates images classified according to categories. The evaluation unit 133 evaluates the image according to various evaluation factors such as sharpness, composition, contrast, and quality of the image, in order to evaluate pictures that are publicly considered attractive or technically excellent. According to an embodiment, the evaluation unit 133 may scan the uploaded image to obtain a picture and compare the picture with a similar image stored in the database, thereby analyzing the aesthetic sense of each image. In an embodiment, by building database of images scored by more than a certain number of people, the rating of the similar images may be determined on the basis of images for which the evaluation is completed.

The matching unit 135 matches pictures for which the evaluation is completed with a user who desires to receive a post card. For example, the matching unit 135 may match the user with pictures including objects that are interested by the user or are considered that a purchase probability is higher through personal information, information of interest, and cookie information of the user. Specifically, when a particular field of interest and object of interest of the user is set as clothing or interior, the user is matched with pictures included in the corresponding category.

The primary depth content creation unit 151 of the creation module 150 generates primary depth content of a post card image to be transmitted to the user among the matched pictures. According to an embodiment, the primary depth content creation unit 151 extracts objects that the user recently has attempted to purchase, and selects the background image included in the extracted objects, thereby creating primary depth content. In addition, it is possible to generate the primary depth content by selecting images associated to the season in a region where the user is located, or extracting images that are popular in the gender and age of the user.

The secondary depth content creation unit 153 extracts a plurality of objects included in the primary depth content extracted as the post card image, identifies metadata of each of the extracted objects, and extracts user cookie data that matches the identified metadata or whose relevance to metadata is equal to or higher than a certain level. Thereafter, URLs included in the extracted user cookie data are linked to the object, or URLs associated with the metadata of the object are linked to the object, thereby creating secondary depth content.

According to an embodiment, in order to calculate the relevance between the object metadata and the user cookie data, the secondary depth content creation unit 153 identifies the relevance, similarities, and inclusion relationship between the object metadata and the cookie data through data mining, and extracts the cookie data representing a certain level of relevance, thereby linking the object to the cookie data.

The third depth content creation unit 155 creates third depth content including a purchase link and detailed information of the object included in the secondary depth content. In addition, according to the embodiment, the third depth content creation unit 155 may provide information related to objects included in the secondary depth content and other user preference information via linking. The links provided in the secondary depth content and the third depth content according to the embodiment may include not only purchase links, but also links to related information provided by search portals such as YouTube, Amazon, or Google.

The connection count calculation unit 171 of the calculation module 170 calculates the number of connection times that the user who has received the related content accesses the primary depth content, the secondary depth content, and the third depth content and thus calculates advertisement rewards proportional to the number of connection times. In an embodiment, the rewards may be calculated differently according to the dimension of depth content. That is, when the user accesses the secondary and third depth content, rather than the primary depth content, the advertising effect is increased and the purchase probability is improved, whereby the rewards may be calculated in proportional to the dimension of depth content.

The purchase confirmation unit 173 confirms whether a user has purchased a product through the related content. According to an embodiment, by confirming not only whether the purchase occurs through the purchase link provided together with the related content, but also whether the purchase occurs after the related content is provided, the rewards may be calculated. For example, when the user makes a purchase within a certain time after the related content is provided, the purchase confirmation unit 173 is configured to provide a certain portion of the revenue generated from the purchase to an administrator of the image providing system as rewards.

The reward calculation unit 175 calculates a reward and an advertisement reward provided to a user who uploads pictures. When the image information registered by the user on the image providing server related to the user information of interest is selected as primary depth content of other user and thus transmitted to the other user, the reward may be provided to the user in proportion to the transmission frequency and the number of times that the image is selected as the primary depth content. In addition, when a purchase event occurs through the purchase link included in the related content, the reward calculation unit 155 calculates the actual purchase amount and thus calculates the advertising reward proportional to the purchase amount.

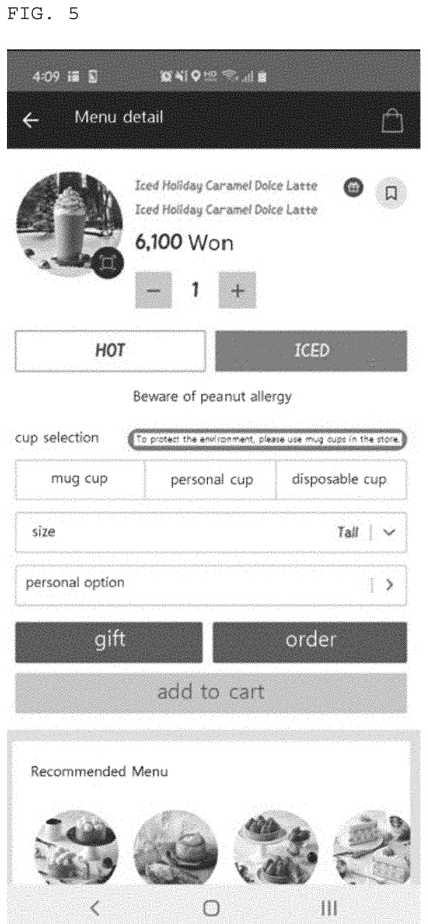

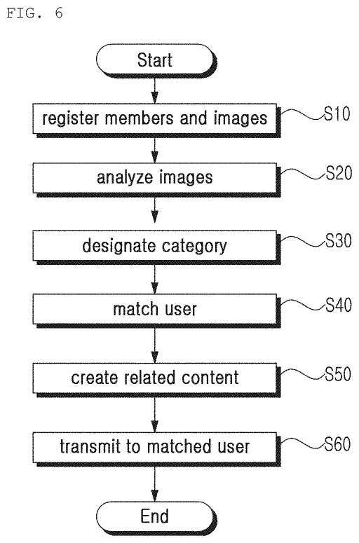

FIG. 4 is a diagram showing primary depth content and secondary depth content according to an embodiment; and FIG. 5 is a diagram showing third depth content according to an embodiment.

Referring to FIG. 4, the primary depth content according to an embodiment is an image (a) in the form of a post card related to an object or field of interest that a user prefers. The primary depth content (a) shown in FIG. 4 is a picture extracted when the user information of interest is coffee or cafe. The user may touch the object 16 included in the primary depth content (a) and thus confirm the secondary depth content (b). As for the secondary depth content, information related to the object 16 touched by the user and metadata of the object may be output. In addition, a link providing the object 16, promotion information, and event information may also be output as the secondary depth content. Specifically, referring to FIG. 4, according to an embodiment, when the user touches the coffee company name object 16 included in the primary depth data, the touched object may output information on events held by the coffee company and popular beverage information as the secondary depth content. When the user touches the object 17 included in the secondary depth content, third depth content shown in FIG. 5 are output. Referring to FIG. 5, the third depth content may include a purchase link, price, and detailed information of the object touched by the user. When the user sets the related content by omitting purchase and advertisement content on the server, the secondary and third depth content do not provide purchase and advertisement links, but provide links to pages providing preference information according to the user personal information and information related to the object.

In addition, according to the embodiment, the primary depth content, which is the user preference image, is output in the form of a post card, so that the user is enabled to use the primary depth content offline. In addition, according to the embodiment, it is possible to output detailed information on an object included in the primary depth content or information selected by the user, together with the primary depth content. In addition, according to the embodiment, when the primary depth content is created in 3D and connected to the 3D printer, the primary depth content is output to the connected 3D printer so that the user is enabled to use the primary depth content in the real world.

Hereinafter, a method of providing multi-dimensional information using a user preference image will be described. Since operations (functions) of the method for providing multi-dimensional information according to an embodiment is essentially the same as functions of the user image providing server, the description overlapping with FIGS. 1 to 5 will be omitted.

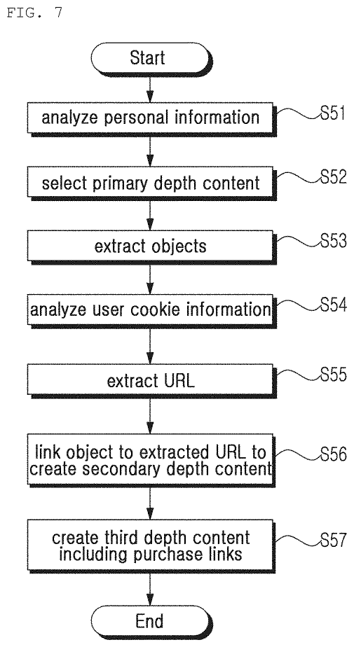

FIG. 6 is a flow chart showing data processing for providing multi-dimensional information using a post card image according to an embodiment.

In step S10, in an image providing server, personal information, interest information, and terminal information of a user and images created by the user or stored in an external server are registered.

In step S20, the registered image is analyzed to evaluate the quality of the image, and in step S30, a category for each image is designated. According to an embodiment, it is possible to evaluate pictures that are considered to be attractive by the general public or are technically superior, in terms of the images registered in the server. For example, steps S20 and S30 may be performed by an image analysis artificial intelligence program. Specifically, in step S20, the uploaded pictures are scanned and compared with similar images stored in the database, thereby analyzing an aesthetic sense by extracting evaluation factors such as composition, color, brightness, sharpness, and image quality of the image. In addition, the image providing server according to the embodiment builds the database containing quantification of image quality and aesthetics in advance, so that the database may be used in the image analysis and evaluation process.

In step S40, the information of interest and personal information registered by the user is compared with category information of the image to match the image with the user, and in step S50, one of the matched images is extracted to create related content which is to be transmitted to the user.

In step S60, the created related content is transmitted to the matched user.

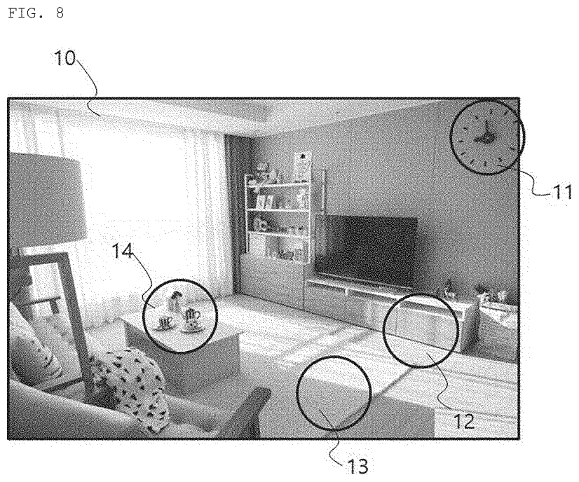

FIG. 7 is flow chart showing data processing for creating related content according to an embodiment.

In step S51, personal information and cookie information of a user are analyzed. In step S52, the primary depth content is extracted according to the analysis result of the personal information and cookie information. For example, when the user inputs information of interest and a field of interest, the image representing the input information is selected. In step S53, objects included in the selected image are extracted. In step S54, cookie information of objects that have a relevance of a certain level or more with the primary depth content or that are particularly interested by the user is selected through analysis of the user cookie information. In step S55, the URL is extracted from the selected information, and in step S556, the secondary depth content is created by linking the extracted URL to the objects included in the primary depth content. In step S57, the third depth content is created by linking purchase content, advertisement content, and additional information content to the objects and icons included in the secondary depth content.

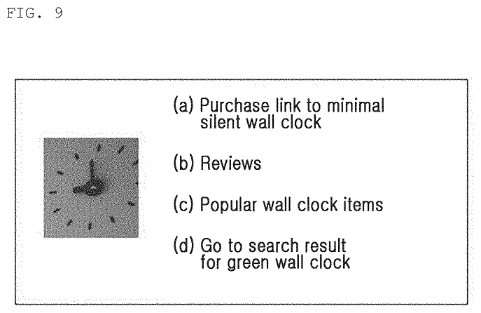

FIG. 8 is a diagram showing primary depth content according to an embodiment; and FIG. 9 is a diagram showing secondary depth content and third depth content according to an embodiment.

Referring to FIG. 8, when an image providing server user inputs a field of interest as “interior design”, a related image 10 is created as the primary depth content. According to the embodiment, the related image of the field of interest may be extracted using not only a field of interest directly input by the user, but also a web access record stored in the user terminal. When the primary depth content is created according to the embodiment, objects included in the primary depth content are extracted. According to the embodiment, products included in the primary depth content related to interior design, such as a wall clock 11, a side table 12, a carpet 13, and a mug 14 may be extracted as the objects. The extracted objects may be linked to URLs that provide purchase information of the products and additional information. FIG. 9 is a diagram showing the secondary depth content generated according to an embodiment. When the user touches an object of the wall clock according to the embodiment, a URL linked to the touched object is output to the user. According to the embodiment, the secondary depth content may be composed of related information such as purchase links, reviews, popular products, and search results.

According to the method of providing multi-dimensional information using a post card and the image providing system as described above, information desired by the user can be compressedly provided in a single image, by creating images that the user prefers as the primary depth information using the cookie information and personal information stored in the smart terminal of the user, and linking the created primary depth information to all URLs capable of identifying detailed information of the objects extracted as user information of interest.

In addition, since the one-dimensional related information transmitted to the user is created in the form of a post card in consideration of user preference information, it is possible to provide the information to users without a feeling of rejection to advertisement content, unlike advertisement brochures and pamphlets that are uniformly provided to consumers. Accordingly, the embodiment according to the present disclosure may be used in the form of customized advertisement content for various stores such as a department store to improve the advertisement effect.

In addition, rewards are provided to users who upload high-quality images and users who upload images with high preference to generate additional revenue.

Since the disclosed contents are only examples and various changes may be made by those of ordinary skill in the art without departing from the gist of the claims claimed in the claims, the scope of protection of the disclosed content is not limited to the specific embodiments described above.

1. A method of providing multi-dimensional information using a post card of an image providing system, the image providing system including an image providing server and a user terminal, the method comprising:
by the image providing server, selecting a post card image to be transmitted to a user using cookie information and personal information of the user terminal to create first depth content in consideration of user preference;
by the image providing server, extracting multiple objects included in the selected post card image to create secondary depth content by linking to URLs outputting metadata of the extracted objects and information associated with the cookie information or the personal information; and
by the image providing server, outputting the created secondary depth content via user selection to create third depth content including a purchase link or object related information included in the output secondary depth content.

2. The method of claim 1, wherein the selecting of the post card image includes:
extracting products that the user has attempted to purchase through cookie data analysis and selecting background images including the extracted products to create the first depth content, or
selecting images associated with a season of a region where the user is located or extracting images having a preference of a certain level or higher in a gender and age of the user, and converting a size of the extracted images to create the first depth content.

3. The method of claim 1, wherein the extracting of the multiple objects includes:
extracting the objects including the first depth content selected as the post card image;
identifying the metadata of each of the extracted objects to extract user cookie data having a relevance of a predetermined level or higher to the identified metadata; and
linking the objects to URLs included in the extracted user cookie data or URLs for providing the metadata of the objects.

4. The method of claim 1, wherein the selecting of the post card image includes:
when the registered image is selected as first depth content of other user and transmitted to the other user, providing rewards according to the number of times the registered images are selected as the first depth content and a transmission frequency.

5. The method of claim 1, wherein the outputting of the created secondary depth content includes:
when an actual purchase event occurs in the purchase link provided in the third depth content, providing rewards to the user who has registered the primary depth content according to a purchase amount.

6. A system for providing multi-dimensional information, comprising:
a user terminal transmitting user personal information, cookie information, and stored images; and
an image providing server classifying the received image, selecting preference images according to the user personal information and cookie information, inserting multi-dimensional information into the selected preference images to create related content, and transmitting the created related content to the user terminal.

7. The system of claim 6, wherein the image providing server includes:
a database storing the user personal information and the received image data;
an analysis module analyzing the stored image, identifying a category in which the analyzed image is to be included, and determining a quality of the image according to evaluation factors including definition, composition, sharpness, and number of recommendations; and
a creation module analyzing the user personal information and cookie information to create first depth content, which is a post card image to be transmitted to the user,
in which the creation module
extracts each of multiple objects included in the selected post card image to create secondary depth content by linking the extracted objects to URLs outputting metadata of the extracted objects or user information of interest, and
outputs the created secondary depth content via user selection by the image providing server associated with the user information interest to create third depth content including a purchase link or detailed information of objects included in the output secondary depth content.

8. The system of claim 7, wherein the creation module:
extracts products that the user has attempted to purchase through cookie data analysis and selecting background images including the extracted products to create the first depth content, or
selecting images associated with a season of a region where the user is located or extracting images having a preference of a certain level or higher in a gender and age of the user, and converting a size of the extracted images to create the first depth content.

9. The system of claim 7, wherein the creation module extracts the objects including the first depth content selected as the post card image, identifies the metadata of each of the extracted objects to extract user cookie data having a relevance of a predetermined level or higher to the identified metadata, and links the objects to URLs included in the extracted user cookie data or URLs for providing the metadata of the objects.

10. The system of claim 6, wherein the image providing server, when the registered image is selected as first depth content of other user and transmitted to the other user, provides rewards according to the number of times the registered images are selected as the first depth content and a transmission frequency.
